(19) United States
(12) Patent Application Publication
(10) Pub. No.: US 2002/0112993 A1
(43) Pub. Date: Aug. 22, 2002

(54) Fractionater revamp for two phase feed

(76) Inventor: Frank Paul Puglisi, Woodbury, MN (US)

Correspondence Address: Marathon Ashland Petroleum LLC, Richard D. Stone, 539 South Main Street, Findlay, OH, 45840, US

(21) Appl. No.: 09/951,987

(22) Filed: Sep. 13, 2001

Related U.S. Application Data
(60) Provisional application No. 60/232,478, filed on Sep. 13, 2000.

(51) Int. Cl. B01D 3/00

(52) U.S. Cl. 208/347; 208/350; 208/351

(57) ABSTRACT

A method of reducing the amount of energy required to fractionate a liquid hydrocarbon fraction is disclosed. Rather than use a single liquid feed point for a distillation column, the liquid feed is split into an upper feed portion and a lower feed portion. The lower feed portion is preheated to produce a vapor rich feed to a lower feed portion of the column, while charging, as a liquid, the remaining feed to an upper feed location at least one theoretical stage above the normal, single feed point location. Splitting the feed in this way reduces the total amount of heat required to reboil the column.

### FIELD OF THE INVENTION

The invention relates to fractional distillation of hydrocarbons and the like.

### BACKGROUND OF THE INVENTION

Fractional distillation is perhaps the oldest refinery process. A multicomponent feed is usually heated and then charged to a distillation column with multiple stages of vapor liquid contact, provided either by trays or a column packing. The complex, or at least two component, mixture is subjected to multiple vaporizations and condensations, producing one or more normally liquid products and at least one vapor phase product. Usually additional heat is added to the bottom of the column via a reboiler. Usually a portion of the vapor phase product is cooled and condensed and returned to the distillation column as reflux.

The distillation process is used in every petroleum refinery in the world, essentially all chemical plants, and in a variety of other processes. It is perhaps the most thoroughly studied unit operation of chemical engineering, and detailed discussion of the process is not necessary.

Despite the maturity of the process, refiners and others skilled in the fractionation arts are constantly trying to improve the process, generally with a view to increasing the throughput or separation efficiency of their distillation towers. Of special concern is reducing the amount of energy, or at least the amount of high grade energy consumed by the distillation process.

In a modern refinery, there are not many ways to increase the energy efficiency of a fractionator or tower. The refinery is stuffed with fractionators built years ago. Some improvement in energy efficiency could be achieved by replacing the tower completely with a more modern one, or by using more efficient tower packing, or by going to high efficiency trays. All of these modifications will work but are expensive, usually so expensive that the capital investment can not be justified based on the energy savings.

Refineries usually do have a lot of low grade or waste heat available, in the form of low pressure steam or other low temperature heat source. There is no cost effective way to generate power from this energy and a lot of heat energy is simply spilled into the air or water via fin fan coolers or excessive use of cooling water.

Some efforts have been made to improve the energy efficiency of fractionators by using this waste heat to provide additional preheat for distillation column feed. Wankat and Kessler disclosed the energy saving possibilities of this approach in Two-Feed Distillation: Same-Composition Feeds with Different Enthalpies, Ind. Eng. Chem. Res. 1993, 32, 3061-3067. They suggested increasing the amount of preheat to increase the vaporization of the feed. This use of low grade heat could be used to, e.g., increase feed vaporization reduced the amount of high grade heat which had to be added to the base of the column. This well preheated feed would then be separated into a vapor fraction and a liquid fraction and feeding these streams at different points in the column. The vapor rich (or well pre-heated) fraction was feed a few trays down from the old feed point location and the liquid rich (not well pre-heated) fraction was added to the column a few trays above the old feed point.

Increasing the amount of feed preheat and use of a two-enthalpy-feed system could be used to:

Reduce reflux ratio need, or

Improve separation, or

Reduce reboiler heat input and/or temperature, or

Reduce the number of theoretical trays required.

Thus the two-enthalpy feed system used the feed and liquid fractions to do some work in the distillation column. In a sense the relatively less heated liquid feed acted as an internal reflux stream while the relatively more heated and more vapor rich fraction was an internal reboiler. As more elegantly stated by the authors:

“. . . splitting a stream before heating (or cooling) a portion of the stream generates a chemical potential difference which can be used either to develop useful additional separation or to reduce the energy requirements in a distillation system.”

While these improvements are real, they are neither intuitive nor readily used in a typical refinery fractionator.

They are not intuitive because many chemical engineers want to put the feed to a column at a point where key vapor and liquid components in the feed match the same components in the column. The two-enthalpy feed process teaches adding feed above and below the old feed point location, but the vapor and liquid feed streams have roughly the same composition.

These improvement are not readily implemented into a typical existing refinery column because the cost of providing new feed points for both vapor and liquid streams can not be justified in many cases.

I discovered that it was possible to achieve most, and indeed essentially all, of the benefits of the two-enthalpy feed approach while avoiding most of the cost associated with changing two feed point locations. I discovered that it was possible to keep the old column feed point location for the vapor rich feed and install only a new liquid feed line one or more trays higher up in the column. The cost of a suitable liquid feed inlet distributor on the higher tray and liquid line to the new liquid inlet are minimal as compared to the cost of a new vapor line and vapor distributor. U.S. Pat. No. 5,230,839 is mentioned to show how complex a feed distributor can be.

In my process, the existing feed inlet for a column is used for the vapor rich two-enthalpy feed. The existing equipment is generally suitable, especially as some of the liquid loading is diverted to a higher tray in the column. This is not much of a change in liquid loading, but directionally it helps. The vapor rich feed point will usually still contain some liquid, just not all the liquid feed added to the column.

This modified approach to the two-enthalpy feed system can achieve most of the benefits—typically 80 to 90%—of the new approach to distillation but avoids most of the cost—typically avoiding 50-80%—of modifying the column.

### BRIEF SUMMARY OF THE INVENTION

Accordingly, the present invention provides A process for reducing the amount of energy required to reboil a fractionator fractionating a liquid feed which is charged to an intermediate portion of a fractionation column at an initial feed point location, wherein said fractionator is reboiled by removing a bottoms liquid fraction from a bottom stage of said fractionator and heating to produce vapors which are returned to said bottom stage or a vapor space above said bottom stage to provide heat in the form of vaporized bottom liquid to boil liquids therein and promote fractionation, said process comprising, splitting said liquid feed into an upper feed portion and a lower feed portion, increasing the enthalpy of said lower feed portion in a preheating means to produce a vapor rich lower feed portion with an increased vapor content and charging said vapor rich portion to said feed point location, charging said upper feed portion as a liquid to a new upper feed point location at least one theoretical stage above said initial feed point location, and reducing the amount of heat used to reboil said column.

1. In another embodiment a method of revamping a reboiled fractionator receiving a liquid feed at a liquid feed introduction point and producing a heavy liquid product from a bottom portion is said fractionator which is a least partially reboiler to produce vapor which is returned to said fractionator and one or more light liquid products from an upper portion of said fractionator to reduce the amount of energy added via a reboiler and increase the amount of energy added via feed preheat, providing a feed splitting means to split said liquid feed into an upper feed portion and a lower feed portion, providing a heat exchange means operatively connected with said lower feed portion for heating said lower feed to produce a vapor rich lower feed portion with an increased vapor content and discharging said vapor rich portion to said feed point location, and providing means for charging said upper feed portion as a liquid to a new upper feed point location at least one theoretical stage above said initial feed point location.

### BRIEF DESCRIPTION OF THE DRAWINGS

FIG. 1 (Prior Art) is a simplified process flow diagram of a reformer debutanizer.

FIG. 2 (Invention) is a simplified process flow diagram of a revamped debutanizer of the invention with a additional feed preheat and a new liquid feed point.

FIG. 3 (Prior Art) is an optimized process flow for a revamped debutanizer using the published two-enthalpy approach with new vapor and liquid feed points.

FIG. 4 is a comparison of the ratio of light/heavy key components in the above fractionators, by equilibrium stage number.

### DETAILED DESCRIPTION

The process is useful for revamping any fractionation process wherein the feed to the fractionator can be split into a two enthalpy feed with the same or roughly the same composition. In many refinery situations, this will include product fractionators such as reformer debutanizers, depentanizers, depropanizers, and the like.

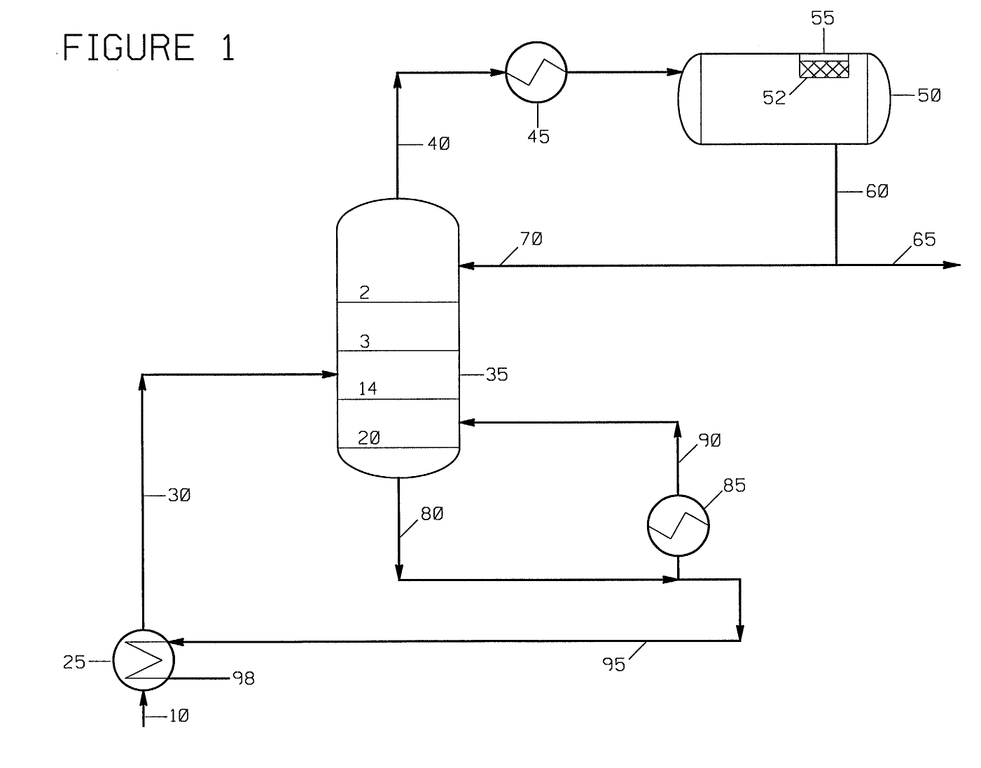

An overview of conventional refinery practice will be given in connection with a review of FIG. 1 (Prior Art), which is a simplified process flow diagram of a reformer debutanizer. A feed mixture, typically the liquid fraction from a vapor/liquid separator associated with a platinum reformer, is charged via line 10 and preheated in heat exchanger 25 by heat exchange with hot, debutanized reformate in line 95, to produce phreheated feed in line 30, a substantial amount of which is vapor. This feed is charged via a conventional vapor/liquid feed inlet located above tray 14 in debutanizer 35, which has a total of 20 trays, though the Fig. Shows only trays 2, 3, 14 and 20. In practice the column might have 30 trays, each of which operates at an efficiency equivalent to about ⅔ of a theoretical tray, or might have 30′ of column packing with an HETP, or Height Equivalent of a Theoretical Plate, of 18″.

A debutanizer overhead vapor stream is withdrawn overhead via line 40 and cooled in cooler 45 which might be a fin fan cooler, or a water cooled cooler, or some other cooling means to produce a cooled overhead vapor/liquid stream which is charged to vapor/liquid separator 50. An overhead vapor stream is passed through demister 52 and removed via line 55 for further processing in means not show. A liquid stream, rich in normal butane and isobutane, is removed via line 60 and a portion is recycled to the distillation column via line 70 to serve as reflux and the remainder removed via line 65 as a product of the process.

A debutanized bottoms liquid fraction is removed via line 80 and a portion passed through reboiler 85 and returned to the column via line 90 and the remainder charged via line 95 to heat exchanger 25 to preheat the incoming feed and produce a cooler reformate liquid which is withdrawn via line 98 for further processing and/or storage as a gasoline blending component.

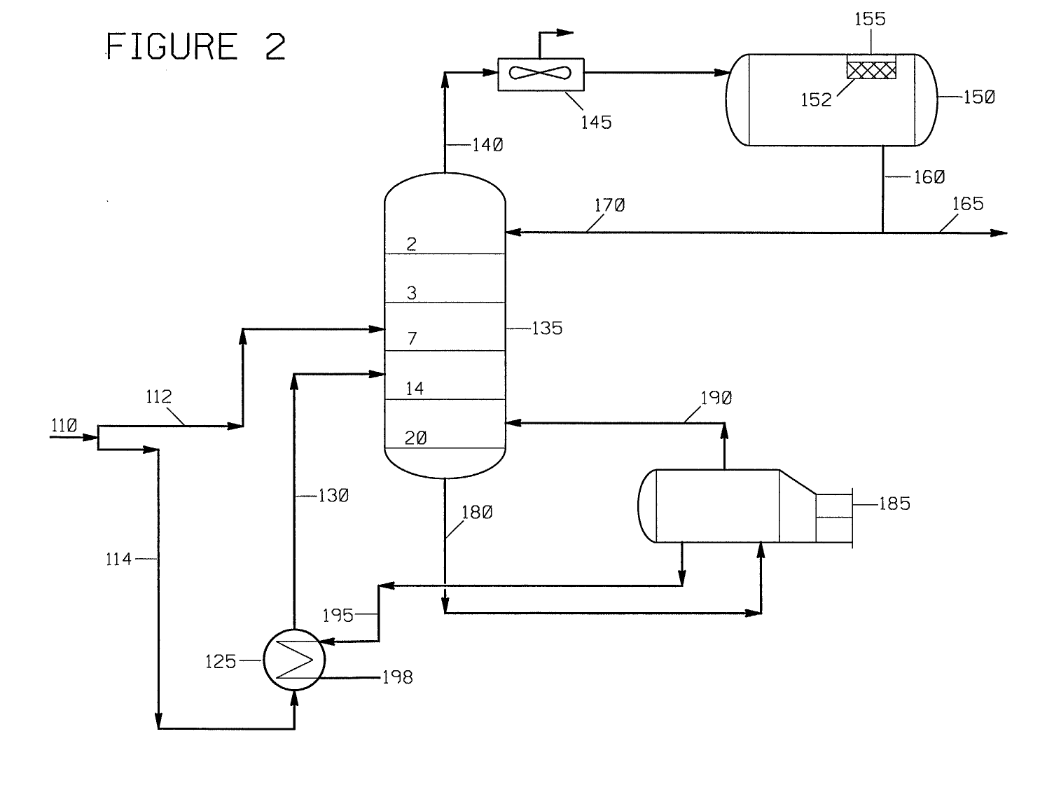

FIG. 2 (Invention) is a simplified process flow diagram of a revamped debutanizer with additional feed preheat and a new liquid feed point. Much of the equipment will be identical to that used in FIG. 1.

The column feed in line 110 is split into a liquid portion which is charged via line 112 to an upper portion of the distillation column 135, above tray 14. The remainder of the feed liquid is charged via line 114 to preheater 125, at least partially vaporized, and charged via line 130 to the pre-existing feed inlet located above tray 14. A liquid bottoms fraction is removed via line 180. A portion is reheated in reboiler 185 and recycled via line 190 to the base of the column. The remainder is charged via line 195 to heat exchanger 125 to preheat fresh feed and cool the reformate to some extent so that it may be discharged via line 198 for further processing.

The overhead vapor is withdrawn from the column via line 140, cooled in cooler 145 and charged to vapor liquid separator 150. A vapor portion passes through demister 152 and is withdrawn as a vapor product via line 155. Liquid is withdrawn via line 160 and either returned as reflux via line 170 or removed as an intermediate product via line 165.

What is different about the FIG. 2 embodiment (Invention) from the FIG. 1 embodiment is that the process of the invention involves splitting the feed into two portions. Additional preheat is added to one portion to produce a partially vaporized feed which is charged to the old feed inlet, above tray 14. The remainder of the fresh feed is not subjected to additional heating and is added to the column roughly 7 trays above the old feed point. The feed composition of the material added to tray 7 is essentially the same as the feed composition of the material added to tray 14. The tray 14 feed has a higher vapor content.

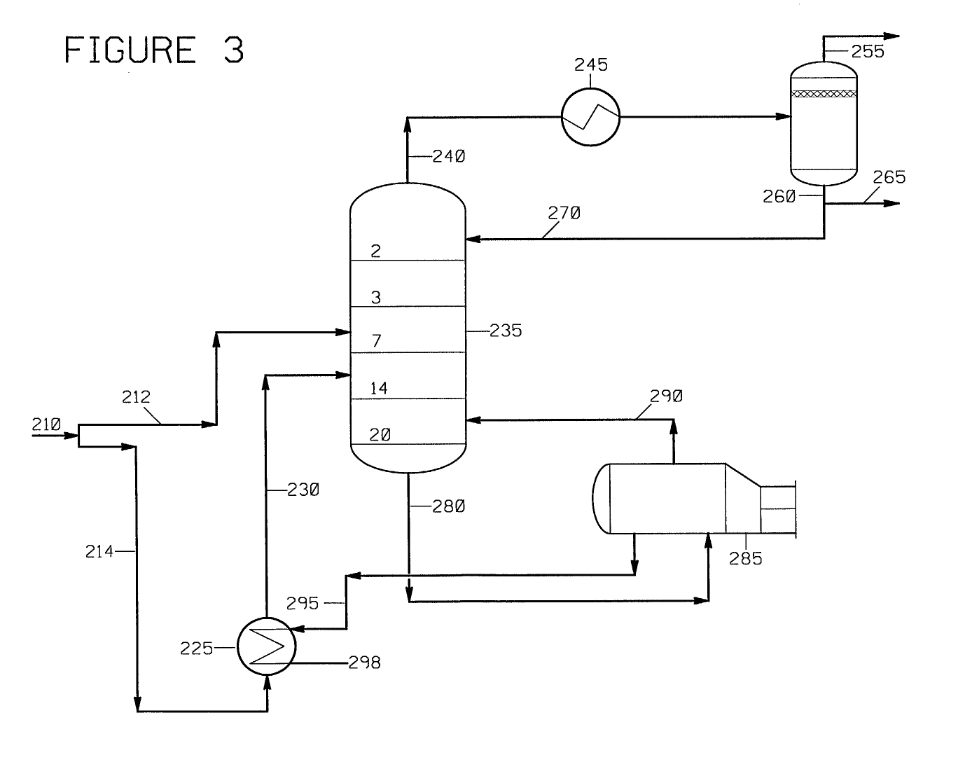

FIG. 3 (Prior Art) is an optimized process flow for a revamped debutanizer using the Wankat and Kessler two-enthalpy approach with new vapor and liquid feed points.

The column feed in line 210 is split into a liquid portion which is charged via line 212 to an upper portion of the distillation column 235, above tray 14. The remainder of the feed liquid is charged via line 214 to preheater 225, at least partially vaporized, and charged via line 230 to the new feed inlet located above tray 17. A liquid bottoms fraction is removed via line 280. A portion is reheated in reboiler 285 and recycled via line 290 to the base of the column. The remainder is charged via line 295 to heat exchanger 225 to preheat fresh feed and cool the reformate to some extent so that it may be discharged via line 298 for further processing. The overhead vapor is withdrawn from the column via line 240, cooled in cooler 245 and charged to vapor liquid separator 250. A vapor portion passes through demister 252 and is withdrawn as a vapor product via line 255. Liquid is withdrawn via line 260 and either returned as reflux via line 270 or removed as an intermediate product via line 265.

What is different about the FIG. 3 embodiment from the FIG. 1 embodiment is splitting the feed into two portions. Additional preheat is added to one portion to produce a partially vaporized feed which is charged to a new feed inlet, above tray 17. The remainder of the fresh feed is not heated and is added to the column roughly 10 trays above the old feed point. The feed compositions are the same, but the tray 17 feed has a higher vapor content.

What is different about FIG. 3 from FIG. 2 (invention) is that the FIG. 2 embodiment uses the old feed inlet at tray 14 for the vapor feed rather than a new feed inlet at tray 17.

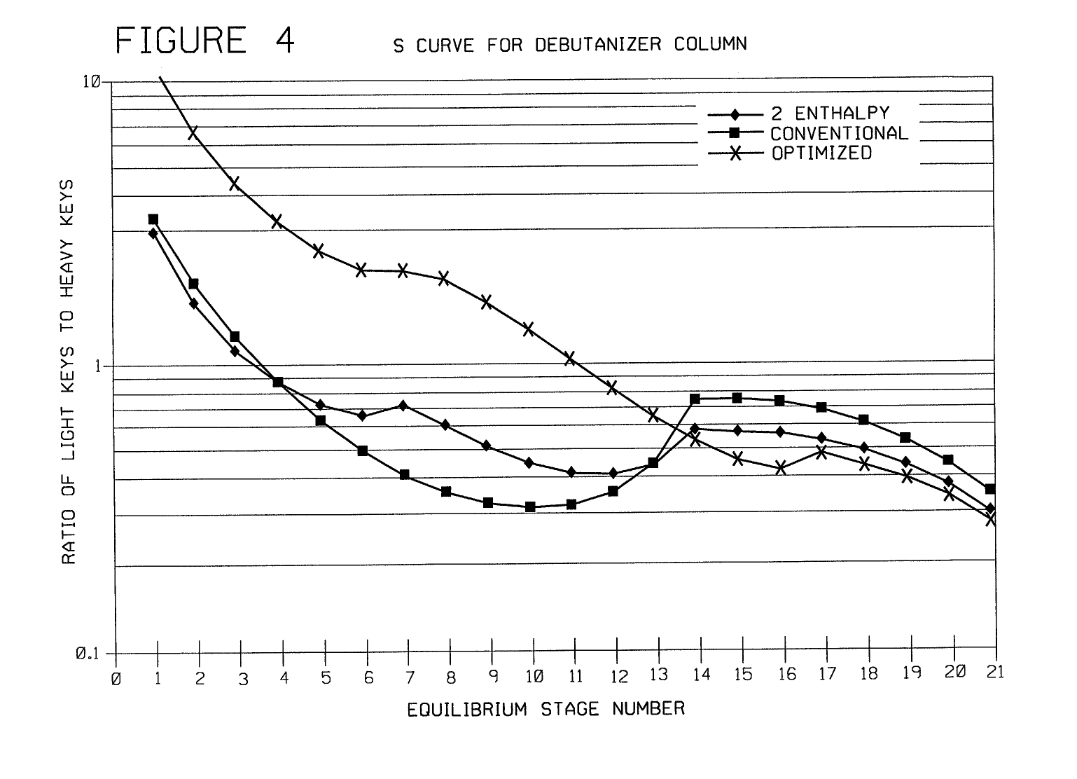

FIG. 4 is a comparison of the ratio of light/heavy key components in the above fractionators, by equilibrium stage number. It graphically presents the ratios of light keys to heavy keys for each distillation approach.

The light key components are iso- and normal butane.

The heavy key components are iso- and normal pentane.

The ration of light/heavy keys is shown for each theoretical stage, from tray 1 to the bottom of the column, counted as tray 21. Squares represent the conventional (FIG. 1) approach, used for decades. The X's represent the “optimized” approach, using new feed points for the upper liquid feed and the at least partially vaporized lower feed. The diamonds (Invention) represent the results achieved with 2 enthalpy feed using the old column feed inlet for the vapor rich feed and a new liquid feed inlet higher up in the column.

The data in FIG. 4 show that all fractionation approaches work and can be used to make satisfactory debutanized reformate. The data do not show energy efficiency, which was the point of studying various column modifications and which is shown in the data presented below.

Computer Simulations

Each fractionation method (FIGS. 1-3) was checked using the Hyprotech Process Simulator, HYSIM, Version STD/C2.63, Prop. Pkg PR This program has been found to be highly reliable and is believed to be more accurate at predicting what occurs in a commercial fractionator than use of pilot plant fractionators. The results are especially reliable because the fractionation problem is relatively simple, there is no water present, the key components are all similar hydrocarbons and no azeotropes will form.

Simulation 1 (Conventional)

This simulates what happens when using the fractionation approach shown in FIG. 1. The column input and specifications are summarized, followed by Table 1 which shows conditions on each stage and heating duty. This is the base case, the way debutanizers usually work, with all the feed added as a liquid to stage 14 of the column.

Hyprotech's Process Simulator HYSIM -
Licensed to Marathon Oil Company

| | | |
|---|---|---|
| Date | Version STD/C2.63 | Case Name DEBUT.SIM |
| Time | Prop Pkg PR | Column Name debut |

*** Column Input ***

| | |
|---|---|
| Number of Real Stages | 21 |

| | | | | |
|---|---|---|---|---|
| Stage | 1 | Pressure | 214.696 | psia |
| Stage | 2 | Pressure | 216.700 | psia |
| Stage | 21 | Pressure | 224.696 | psia |
| Stage | 1 | Temperature Estimate | 100.000 | F. |
| Stage | 21 | Temperature Estimate | 460.000 | F. |

Feed stream hot_debut_fd enters on stage 14
Overhead Vapour Estimated Flow 600.0000 lbmole/hr
Estimated top stage reflux ratio is 2.0000
Side Liquid draw from stage 1 to stream ovhd_liq
Estimated Flow 680.0000 lbmole/hr
Side Exchanger on stage 1 is energy stream cool_q
Side Exchanger on stage 21 is energy stream hot_q
Overhead vapour product goes to stream ovhd_vap
Bottom liquid product goes to stream btms
Note - stage efficiencies are being used!

*** Specifications ***

1: Temperature on stage 1 is to be 100.000. F.
2: LiqVol Fraction of i-Pentane + n-Pentane
in the stage 1 Liquid is to be 0.0500
3: LiqVol Fraction of i-Butane + n-Butane
in the stage 21 Liquid is to be 0.0200

Hyprotech's Process Simulator HYSIM -
Licensed to Marathon Oil Company

| | | |
|---|---|---|
| Date | Version STD/C2.63 | Case Name DEBUT.SIM |
| Time | Prop Pkg PR | Column Name debut |

*** Stage Variables ***
Reflux Ratio 2.90312

| Stg | Press | Temp | Flow Rates | | (barrel/day) | | Duty |
|---|---|---|---|---|---|---|---|
| No | Psia | F. | Liquid | Vapour | Feed | Draws | MMBtu/hr |
| 1 | 214.7 | 100.0 | 10546.1 | | | 773.2 V | −16.216 |
| | | | | | | 2652.2 L | |
| 2 | 216.7 | 155.6 | 11978.9 | 13971.5 | | | |
| 3 | 217.1 | 177.1 | 12279.4 | 15404.3 | | | |
| 4 | 217.5 | 190.8 | 12313.2 | 15704.9 | | | |
| 5 | 218.0 | 201.8 | 12266.8 | 15738.6 | | | |
| 6 | 218.4 | 211.4 | 12193.7 | 15692.2 | | | |
| 7 | 218.8 | 220.1 | 12103.5 | 15619.2 | | | |
| 8 | 219.2 | 228.2 | 11970.6 | 15528.9 | | | |
| 9 | 219.6 | 236.0 | 11732.7 | 15396.0 | | | |
| 10 | 220.1 | 244.3 | 11278.8 | 15158.2 | | | |
| 11 | 220.5 | 254.8 | 10431.4 | 14704.3 | | | |
| 12 | 220.9 | 271.2 | 8974.2 | 13856.8 | | | |
| 13 | 221.3 | 300.6 | 6805.0 | 12399.7 | | | |
| 14 | 221.8 | 357.6 | 39839.8 | 10230.4 | 34498.2 | | |
| 15 | 222.2 | 360.4 | 40298.0 | 8767.1 | | | |
| 16 | 222.6 | 364.6 | 41082.9 | 9225.2 | | | |
| 17 | 223.0 | 370.0 | 42016.1 | 10010.1 | | | |
| 18 | 223.4 | 377.1 | 43094.6 | 10943.4 | | | |
| 19 | 223.9 | 387.5 | 44334.5 | 12021.9 | | | |
| 20 | 224.3 | 404.9 | 45397.1 | 13261.7 | | | |
| 21 | 224.7 | 446.2 | | 14324.3 | | 31072.8 L | 29.424 |

Simulation 2 (Invention)
This simulates what happens when using the FIG. 2 approach.
The feed is split, part of it is added as a liquid higher up in the
column while part is given additional preheat and charged to the old
feed point, stage 14.
Hyprotech's Process Simulator HYSIM -
Licensed to Marathon Oil Company

| | | |
|---|---|---|
| Date | Version STD/C2.63 | Case Name TWOENTH.SIM |
| Time | Prop Pkg PR | Column Name debut |

*** Column Input ***

| | |
|---|---|
| Number of Real Stages | 21 |

| | | | | |
|---|---|---|---|---|
| Stage | 1 | Pressure | 214.696 | psia |
| Stage | 2 | Pressure | 216.696 | psia |
| Stage | 21 | Pressure | 224.696 | psia |
| Stage | 1 | Temperature Estimate | 100.000 | F. |
| Stage | 2 | Temperature Estimate | 176.000 | F. |
| Stage | 21 | Temperature Estimate | 460.000 | F. |

Feed stream hot_debut_fd enters on stage 14
Feed stream debut_fdl enters on stage 7
Overhead Vapour Estimated Flow 600.000 lbmole/hr
Estimated top stage reflux ratio is 2.0000
Side Liquid draw from stage 1 to stream ovhd_liq
Estimated Flow 3969.2000 barrel/day
Side Exchanger on stage 1 is energy stream cool_q
Side Exchanger on stage 21 is energy stream hot_q
Overhead vapour product goes to stream ovhd_vap
Bottom liquid product goes to stream btms
Note - stage efficiencies are being used!

*** Specifications ***

1: Temperature on stage 1 is to be 100.000 F.
2: LiqVol Fraction of i-Pentane + n-Pentane
in the stage 1 Liquid is to be 0.0500
3: LiqVol Fraction of i-Butane + n-Butane
in the stage 21 Liquid is to be 0.0200

Hyprotech's Process Simulator HYSIM -
Licensed to Marathon Oil Company

| | | |
|---|---|---|
| Date | Version STD/C2.63 | Case Name TWOENTH.SIM |
| Time | Prop Pkg PR | Column Name debut |

*** Stage Variables ***
Reflux Ration 1.72416

| Stg | Press | Temp | Flow Rates | | (barrel/day) | | Duty |
|---|---|---|---|---|---|---|---|
| No | psia | F. | Liquid | Vapour | Feed | Draws | MMBtu/hr |
| 1 | 214.7 | 100.0 | 6248.8 | | | 770.9 V | −10.989 |
| | | | | | | 2645.6 L | |
| 2 | 216.7 | 155.6 | 7046.8 | 9665.3 | | | |
| 3 | 217.1 | 175.2 | 7129.0 | 10463.3 | | | |
| 4 | 217.5 | 187.6 | 7008.8 | 10545.6 | | | |
| 5 | 218.0 | 198.5 | 6720.7 | 10425.4 | | | |
| 6 | 218.4 | 211.0 | 6186.1 | 10137.2 | | | |
| 7 | 218.8 | 228.3 | 15647.0 | 9602.6 | 6000.0 | | |
| 8 | 219.2 | 251.2 | 16773.8 | 13063.6 | | | |
| 9 | 219.6 | 264.8 | 17125.6 | 14190.4 | | | |
| 10 | 220.1 | 276.8 | 17147.2 | 14542.1 | | | |
| 11 | 220.5 | 290.0 | 16885.3 | 14563.8 | | | |
| 12 | 220.9 | 307.3 | 16271.7 | 14301.9 | | | |
| 13 | 221.3 | 333.3 | 14940.8 | 13688.2 | | | |
| 14 | 221.7 | 383.6 | 39461.7 | 12357.3 | 28498.0 | | |
| 15 | 222.2 | 382.9 | *39036.9 | 8380.2 | | | |
| 16 | 222.6 | 384.4 | 39230.3 | 7955.5 | | | |
| 17 | 223.0 | 387.0 | 39668.7 | 8148.9 | | | |
| 18 | 223.4 | 391.1 | 40286.0 | 8587.2 | | | |
| 19 | 223.9 | 397.6 | 41094.4 | 9204.6 | | | |
| 20 | 224.3 | 410.1 | 41896.8 | 10013.0 | | | |
| 21 | 224.7 | 445.8 | | 10815.3 | | 31081.4 L | 22.860 |

Simulation 3 (Publication)
This corresponds to the FIG. 3 case, with a portion of the feed given
additional preheat and added to a lower portion of the column while
liquid is added higher up in the column. This is the “optimum” case
and if used would minimize reboiler heat required, but requires adding
both a new vapor inlet and new liquid inlet.
Hyprotech's Process Simulator HYSIM -
Licensed to Marathon Oil Company

| | | |
|---|---|---|
| Date | Version STD/C2.63 | Case Name TWOENTH.SIM |
| Time | Prop Pkg PR | Column Name debut |

*** Column Input ***

| | |
|---|---|
| Number of real Stages | 21 |

| | | | | |
|---|---|---|---|---|
| Stage | 1 | Pressure | 214.696 | psia |
| Stage | 2 | Pressure | 216.696 | psia |
| Stage | 21 | Pressure | 224.696 | psia |
| Stage | 1 | Temperature Estimate | 100.000 | F. |
| Stage | 2 | Temperature Estimate | 176.000 | F. |
| Stage | 21 | Temperature Estimate | 460.000 | F. |

Feed stream hot_debut_fd enters on stage 17
Feed stream debut_fdl enters on stage 7
Overhead Vapour Estimated Flow 600.0000 lbmole/hr
Estimated top stage reflux ration is 2.0000
Side Liquid draw from stage 1 to stream ovhd_liq
Estimated Flow 3969.2000 barrel/day
Side Exchanger on stage 1 is energy stream cool_q
Side Exchanger on stage 21 is energy stream hot_q
Overhead vapour product goes to stream ovhd_vap
Bottom liquid product goes to stream btms
Note - stage efficiencies are being used!

*** Specifications ***

1: Temperature on stage 1 is to be 100.000 F.
2: LiqVol Fraction of i-Pentane + n-Pentane
in the stage 1 Liquid is to be 0.0500
3: LiqVol Fraction of i-Butane + n-Butane
in the stage 21 Liquid is to be 0.0200

Hyprotech's Process Simulator HYSIM -
Licensed to Marathon Oil Company

| | | |
|---|---|---|
| Date | Version STD/C2.63 | Case Name TWOENTH.SIM |
| Time | Prop Pkg PR | Column Name debut |

*** Stage Variables ***
Reflux Ratio 0.75984

| Stg | Press | Temp | Flow Rates | | (barrel/day) | | Duty |
|---|---|---|---|---|---|---|---|
| No | psia | F. | Liquid | Vapour | Feed | Draws | MMBtu/hr |
| 1 | 214.7 | 100.00 | 2731.3 | | | 761.9 V | −6.683 |
| | | | | | | 2625.1 L | |
| 2 | 216.7 | 155.3 | 3037.7 | 6118.3 | | | |
| 3 | 217.1 | 170.6 | 3009.1 | 6424.6 | | | |
| 4 | 217.5 | 179.2 | 2889.5 | 6396.1 | | | |
| 5 | 218.0 | 187.1 | 2681.7 | 6276.5 | | | |
| 6 | 218.4 | 196.9 | 2457.0 | 6068.7 | | | |
| 7 | 218.8 | 206.4 | 17034.0 | 5843.9 | 10000.0 | | |
| 8 | 219.2 | 238.4 | 19338.0 | 10421.0 | | | |
| 9 | 219.6 | 253.8 | 20358.3 | 12724.9 | | | |
| 10 | 220.1 | 264.5 | 20937.4 | 13745.3 | | | |
| 11 | 220.5 | 274.0 | 21341.6 | 14324.3 | | | |
| 12 | 220.9 | 283.3 | 21634.3 | 14728.6 | | | |
| 13 | 221.3 | 293.4 | 21805.8 | 15021.2 | | | |
| 14 | 221.7 | 305.4 | 21809.4 | 15192.7 | | | |
| 15 | 222.2 | 321.2 | 21541.6 | 15196.3 | | | |
| 16 | 222.6 | 344.8 | 20510.6 | 14928.5 | | | |
| 17 | 223.0 | 392.3 | 40337.6 | 13897.6 | 24498.0 | | |
| 18 | 223.4 | 392.8 | 39918.2 | 9226.6 | | | |
| 19 | 223.9 | 397.8 | 40374.8 | 8807.2 | | | |
| 20 | 224.3 | 409.3 | 41072.4 | 9263.8 | | | |
| 21 | 224.7 | 444.4 | | 9961.4 | | 31111.0 L | 21.546 |

ENERGY SAVING/CAPITAL COST SUMMARY:

| | REBOILER DUTY, |
|---|---|
| CASE | MMBtu/hr |
| FIG. 1 (Conventional) | 29.42 |
| FIG. 2 (Invention) | 22.86 |
| FIG. 3 (Publication) | 21.55 |

Discussion

All approaches make on specification product.

The FIG. 3 approach shows the energy savings, or reduction in high grade heat to the reboiler, possible by the approach published by Wankat and Kessler. Splitting the liquid feed, using low grade heat to vaporize some of it and add this at least partially vaporized feed to a lower feed point location while adding the remaining liquid to a higher feed point location. This approach h is brilliant, but requires significant capital expense. In many commercial refineries, it is hard to justify expensive column modifications when the chances are significant that a refinery will be closed, as over 20 refineries have been shut down in the US in the last decade or so.

The FIG. 2 approach (invention) achieves almost all the energy savings of the FIG. 3 approach, but does not require a relatively large and expensive new inlet for vapor rich feed. The liquid feed is added to a new feed point location, higher point in the column. This new line is small because liquid occupies relatively little volume as compared to vapor, and liquids are relatively easy to add to a column. The old feed inlet in the column studied was_i n Sch_pipe. This was large enough to be used to add the vapor rich feed fraction. The new liquid inlet line to tray 7 can be made of_“Sch_pipe.

Feed Mixtures

My process can be used to revamp any existing fractionator receiving a liquid or vapor/liquid feed where there is a source of heat available to vaporize additional amounts of the feed. Suitable refinery installations include fractionators associated with thermal and catalytic reformers, gas concentration plants, MTBE units, alkylation units, hydrotreaters and fractionators designed for all o9r a portion of a crude oil stream. Suitable chemical and petrochemical applications include fractionators associated with cumene units, various specialty products, pitch distillation, ethylene crackers and the like. Alcohol fractionators, whether from grain or wood products, may use this technique.

The feedstocks will include at least two components separable by fractionation. In a refinery, these will usually be hydrocarbons. Sometimes only a few or even just two components will be in the feed and in some applications the feed will comprise complex mixtures of hydrocarbons with over 1000 different compounds.

Fractionators

In almost all instances, the equipment will already be in place, i.e., existing fractionators will be modified or revamped to use the new process. They may be packed towers or contain sieve or bubble cap trays or other proprietary packing material.

If a new fractionator is built, it will be more efficient to use the approach suggested by Wankat and Kessler. This requires a vapor rich feed line to a relatively low portion of the column and a liquid feed line to a relatively high portion of the column. Relative means in relation to the optimum feed point location if only a single feed point were used.

My “revamp” process may be useful in a new column in some situations, primarily where the source of additional feed preheat is interruptible. It may be preferable to design the column with a feed point location optimized for conventional single feed point operation and for two enthalpy feed for times when additional feed preheat is available.

Feed Preheat

The source of the additional feed preheat is not critical. “Low grade” heat is preferred, but not essential—refineries abound with streams that are warmer than fractionator feed streams. In some circumstances, where a fractionator is constrained by flooding in the base of the tower, or a fired heater can not be expanded, it may be desirably to use “high grade” heat to provide additional heat to the feed to the column. Thus the invention permits, but does not require, use of low-pressure steam or relatively low temperature stream to preheat the feed.

I claim:

1. A process for reducing the amount of energy required to reboil a fractionator fractionating a liquid feed which is charged to an intermediate portion of a fractionation column at an initial feed point location, wherein said fractionator is reboiled by removing a bottoms liquid fraction from a bottom stage of said fractionator and heating to produce vapors which are returned to said bottom stage or a vapor space above said bottom stage to provide heat in the form of vaporized bottom liquid to boil liquids therein and promote fractionation, said process comprising:
a) Splitting said liquid feed into an upper feed portion and a lower feed portion,
b) Increasing the enthalpy of said lower feed portion in a preheating means to produce a vapor rich lower feed portion with an increased vapor content and charging said vapor rich portion to said feed point location,
c) charging said upper feed portion as a liquid to a new upper feed point location at least one theoretical stage above said initial feed point location, and
d) reducing the amount of heat used to reboil said column.

2. The process of claim 1 wherein said fractionator is a debutanizer removing C4 and lighter materials.

3. The process of claim 2 wherein said debutanizer removes at least 90% of the total C4 content of the feed and less than 10% of the C5 content of said feed.

4. The process of claim 2 wherein said fractionator has 21 theoretical stages, the initial feed point location is at stage 14 and said upper feed point location is at stage 7.

5. The process of claim 1 wherein 10 to 60% of said feed is charged to said upper feed point location as a liquid.

6. The process of claim 1 wherein said lower feed portion is heated sufficiently to vaporize 10-75% of said lower feed.

7. The process of claim 1 wherein sufficient heat is added via said increased enthalpy vapor feed to reduce the amount of heat added via said reboiler by at least 20%.

8. The process of claim 7 wherein said reboiler heat is reduced at least 25%.

9. The process of claim 1 wherein said upper feed point is at least 3 theoretical stages above said initial feed point.

10. A method of revamping a reboiled fractionator receiving a liquid feed at a liquid feed introduction point and producing a heavy liquid product from a bottom portion is said fractionator which is a least partially reboiler to produce vapor which is returned to said fractionator and one or more light liquid products from an upper portion of said fractionator to reduce the amount of energy added via a reboiler and increase the amount of energy added via feed preheat,
a) providing a feed splitting means to split said liquid feed into an upper feed portion and a lower feed portion,
b) providing a heat exchange means operatively connected with said lower feed portion for heating said lower feed to produce a vapor rich lower feed portion with an increased vapor content and discharging said vapor rich portion to said feed point location, and,
c) providing means for charging said upper feed portion as a liquid to a new upper feed point location at least one theoretical stage above said initial feed point location.
